(19) United States
(12) Patent Application Publication
(10) Pub. No.: US 2026/0323227 A1
(43) Pub. Date: Oct. 15, 2026

(54) OWN-VOICE PROCESSING IN EAR-WORN DEVICES

(71) Applicant: Fortell Research Inc., New York, NY (US)

(72) Inventors: Igor Lovchinsky, New York, NY (US); Abraham Neben, Hamden, CT (US); Nathan Agmon, New York, NY (US); Israel Malkin, Manhattan Beach, CA (US); Mark Berry, Berlin (DE); Nicholas Morris, Brooklyn, NY (US); Ivo Merks, Eden Prairie, MN (US)

(21) Appl. No.: 19/644,543

(22) Filed: Apr. 10, 2026

Related U.S. Application Data
(60) Provisional application No. 63/786,547, filed on Apr. 10, 2025.
(60) Provisional application No. 63/935,676, filed on Dec. 10, 2025.

(51) Int. Cl. H04R 25/00; G10L 21/0272

(52) U.S. Cl. CPC H04R 25/507; G10L 21/0272

(57) ABSTRACT

The present disclosure provides an ear-worn device that may include processing circuitry having neural network circuitry configured to separate speech from noise in an audio signal and own-voice detection circuitry configured to determine whether a wearer is talking. The processing circuitry may apply own-voice processing to the speech when the wearer is talking. The device may include memory storing own-voice and non-own-voice processing parameters, and post-processing circuitry may process the speech using own-voice processing parameters when the wearer is talking and non-own-voice processing parameters when not talking. The device may include motion sensing circuitry configured to generate motion signals, and the own-voice detection circuitry may receive post-neural network outputs and motion signals to perform fusion for determining whether the wearer is talking.

### BACKGROUND

### Field

The present disclosure relates to ear-worn devices. Some aspects relate to own-voice processing in ear-worn devices.

### Related Art

Ear-worn devices, such as hearing aids, may be used to help those who have trouble hearing to hear better. Typically, ear-worn devices amplify received sound. Some ear-worn devices may attempt to reduce noise in received sound.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

For a wearer of an ear-worn device such as a hearing aid, cochlear implant, or earphone, hearing one’s own voice can be particularly uncomfortable. Own-voice may sound unnatural, too loud, or distorted for one or more of the following reasons: 1. If the ear-worn device blocks the ear canal, the user's voice may become trapped, making it sound boomy, hollow, or echoey. This may also be referred to as the “occlusion effect” 2. Ear-worn devices may boost lower frequencies, which may make the wearer’s voice sound deeper or more resonant than usual 3. Ear-worn devices may pick up sound from microphones outside the ear, which may alter the way the wearer hears their own voice compared to the natural bone-conducted and air-conducted paths. Generally, the ideal acoustic response for comfortably hearing other people likely differs from the ideal acoustic response for hearing one’s own voice.

Recently, neural networks in ear-worn devices for separating speech audio from noise audio and focusing on speech from different spatial directions rather than others have been developed. Further description of such neural networks may be found in U.S. Patent No. 11,812,225, titled “Method, Apparatus and System for Neural Network Hearing Aid,” issued Nov. 7, 2023, which is incorporated by reference herein in its entirety; and in U.S. Patent No. 11,937,047, entitled “Ear-Worn Device with Neural Network for Noise Reduction and/or Spatial Focusing Using Multiple Input Audio Signals,” and issued Mar. 19, 2024, which is incorporated by reference herein in its entirety. Noise reduction as referred to herein should be understood to include both background noise reduction (i.e., separating speech from non-speech) and spatial focusing (i.e., separating speech based on direction-of-arrival). The inventors have recognized that once speech has been separated from noise (where noise may be understood to include both background noise and speech from non-target directions), the ear-worn device may be configured to detect whether the speech represents the wearer’s own voice, and if so, apply special own-voice processing to the speech. Because speech and noise may be separated into different audio signals, in some embodiments the own-voice processing may be applied specifically to the speech but not to the noise.

In some embodiments, a robust approach to own-voice detection may involve fusion of multiple independent signals to enhance detection accuracy across various acoustic environments. For example, the ear-worn device may be configured to detect correlations between motion signals and audio signals, which may provide a reliable indication of own-voice activity. In noisy environments, audio signals upstream of neural network processing may contain significant background noise that can interfere with correlation analysis between motion and audio data. However, when signals downstream of neural network processing are used for correlation analysis, the enhanced signal quality after noise reduction may enable reliable own-voice detection even in challenging acoustic conditions. The fusion of motion data with post-neural network output may provide improved robustness for own-voice detection.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1 illustrates an ear-worn device with processing circuitry and neural network components, according to aspects of the present disclosure.

FIG. 2 illustrates the processing circuitry of FIG. 1 with pre-processing and post-processing components, according to aspects of the present disclosure.

FIG. 3 illustrates signal processing operations for generating an output audio signal using a mask, according to aspects of the present disclosure.

FIG. 4 illustrates own-voice detection circuitry receiving input from a bone conduction microphone, according to aspects of the present disclosure.

FIG. 5 illustrates the own-voice detection circuitry of FIG. 1 receiving input from motion sensing circuitry, according to aspects of the present disclosure.

FIG. 6 illustrates the own-voice detection circuitry of FIG. 1 including neural network circuitry, according to aspects of the present disclosure.

FIG. 7 illustrates the own-voice detection circuitry of FIG. 1 receiving motion signals and post-neural network outputs, according to aspects of the present disclosure.

FIG. 8 illustrates a hearing aid as an example of the ear-worn device of FIG. 1, according to aspects of the present disclosure.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

The aspects and embodiments described above, as well as additional aspects and embodiments, are described further below. These aspects and/or embodiments may be used individually, all together, or in any combination of two or more, as the disclosure is not limited in this respect.

Generally, in the technology described herein, an ear-worn device (e.g., the ear-worn device 100 described below, which may be, for example, a hearing aid, cochlear implant, or earphone) may be configured to separate speech from noise in an audio signal using a neural network (e.g., as implemented by the neural network circuitry 114 described below), determine whether the wearer of the ear-worn device is talking (e.g., using the own-voice detection circuitry 116 described below), and if the wearer of the ear-worn device is talking, apply own-voice processing to the speech in the audio signal (but in some embodiments, not to the noise). Speech of the wearer may be referred to as “own-voice.” Further description of speech and noise separation, own-voice detection, and own-voice processing may be found below.

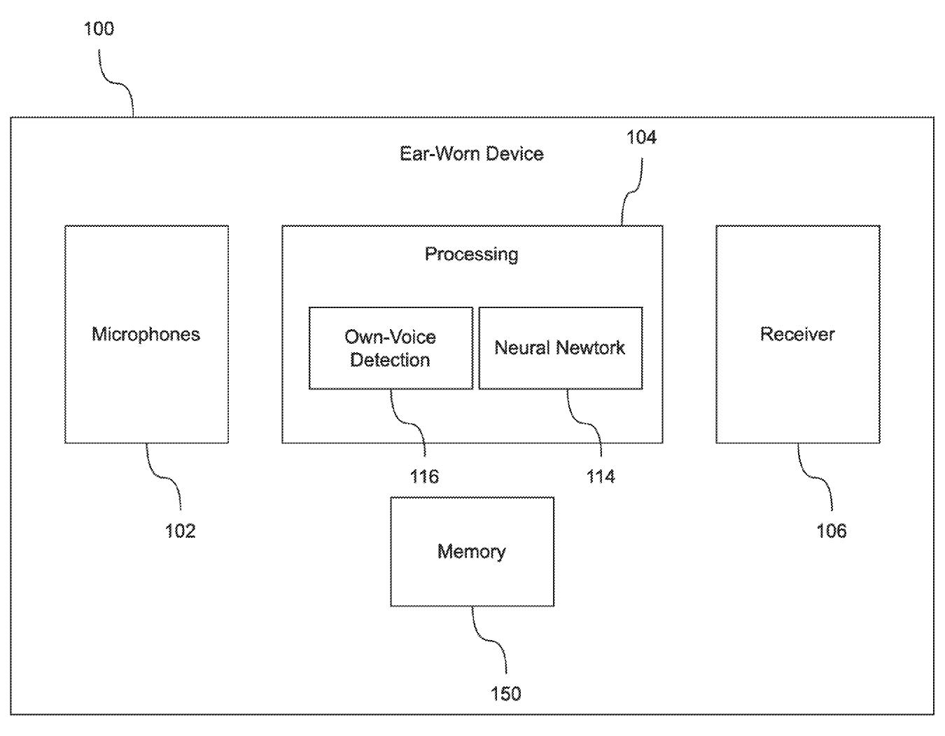

FIG. 1 illustrates an ear-worn device 100, in accordance with certain embodiments described herein. The ear-worn device 100 may be, for example, a hearing aid, a cochlear implant, or an earphone. The ear-worn device 100 includes microphones 102, processing circuitry 104, a receiver 106, and memory 150. The processing circuitry 104 includes (but is not limited to) own-voice detection circuitry 116 and neural network circuitry 114. The neural network circuitry 114 may be configured to implement a neural network (or, more generally, one or more neural network layers).

The one or more microphones 102 may include one, two, or more than two (e.g., 3, 4, or more) microphones. For example, the one or more microphones 102 may include two microphones, a front microphone that is closer to the front of the wearer of the ear-worn device 100 and a back microphone that is closer to the back of the wearer of the ear-worn device 100. As another example, the one or more microphones 102 may include more than two microphones in an array. In some embodiments, microphones in an array may be linked via wireless communication (e.g., the microphones may be disposed on two different ear-worn devices configured for binaural communication). In some embodiments, microphones in an array may be linked internally (e.g., the microphones may be disposed on different portions of hearing aids in an eyeglasses form factor). The one or more microphones 102 may be configured to receive sound signals and to generate audio signals from the sound signals.

The processing circuitry 104 may be configured to process the audio signals from the microphones 102. The processing circuitry 104 may be configured to perform some or all of input calibration, anti-feedback processing, wind reduction, short-time Fourier transformation (STFT), wide dynamic range compression (WDRC), inverse STFT, and output calibration. The processing circuitry 104 may be additionally configured to perform neural network-based noise reduction, in addition to own-voice detection using the own-voice detection circuitry 116; further description may be found below. In some embodiments, the processing circuitry 104 may be configured to use processing parameters stored in the memory 150. These processing parameters may include own-voice processing parameters and non-own-voice processing parameters.

The receiver 106 may be configured to play back the output of the processing circuitry 104 as sound into the ear of the wearer. The receiver 106 may also be configured to implement digital-to-analog conversion prior to the playing back.

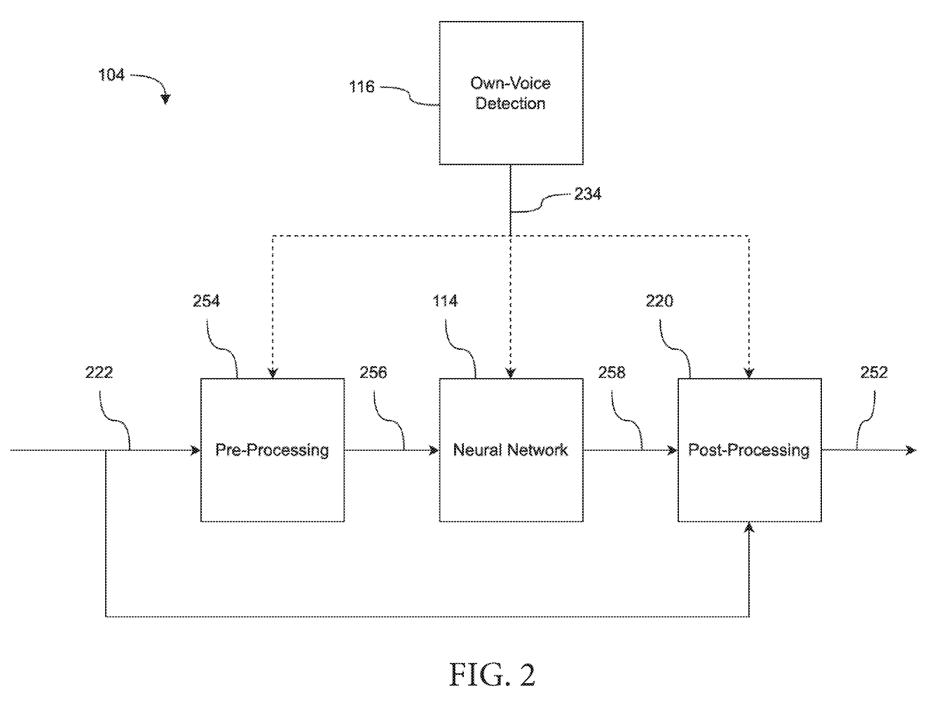

Referring to FIG. 2, the processing circuitry 104 of the ear-worn device 100 includes multiple interconnected components configured to perform audio signal processing operations. The processing circuitry 104 includes pre-processing circuitry 254, neural network circuitry 114, and post-processing circuitry 220, where each component may be configured to perform distinct signal processing operations on audio data. The pre-processing circuitry 254 may be configured to receive one or more microphone signals 222 and generate one or more audio signals 256 for subsequent processing. The neural network circuitry 114 may be configured to receive the one or more audio signals 256 and generate one or more neural network outputs 258 based on trained neural network operations. The post-processing circuitry 220 may be configured to receive the one or more neural network outputs 258 and generate an output audio signal 252 for final output.

The pre-processing circuitry 254 may be configured to perform various processing operations on the one or more microphone signals 222 received from microphone elements. In some cases, the pre-processing circuitry 254 may be configured to perform analog processing operations including analog preamplification to boost signal levels and/or analog filtering to remove unwanted frequency components or noise. The analog preamplification may include low-noise amplification stages configured to increase signal amplitude while maintaining signal-to-noise ratio characteristics. The analog filtering may include high-pass filters, low-pass filters, band-pass filters, and/or notch filters configured to shape the frequency response of the microphone signals. The pre-processing circuitry 254 may also be configured to perform digital processing operations including analog-to-digital conversion to transform analog microphone signals into digital representations suitable for further digital signal processing. The analog-to-digital conversion may include sampling operations at various sampling rates and/or quantization operations using different bit depths depending on the specific audio quality and processing requirements.

With continued reference to FIG. 2, the pre-processing circuitry 254 may be configured to perform additional digital processing operations including wind reduction, input calibration, and/or anti-feedback processing. The wind reduction processing may include algorithms configured to detect and attenuate wind noise artifacts that may be present in the microphone signals. The input calibration may include gain adjustment operations, frequency response correction, and/or phase alignment procedures to ensure consistent signal characteristics across multiple microphone channels. The anti-feedback processing may include adaptive filtering algorithms configured to detect and suppress acoustic feedback between output transducers and input microphones. The pre-processing circuitry 254 may also be configured to perform beamforming operations to create directionally sensitive audio signals from multiple microphone inputs. The beamforming operations may generate beamformed audio signals having various directional patterns including cardioids, supercardioids, hypercardioids, and/or dipoles, where each directional pattern provides different spatial sensitivity characteristics.

In some embodiments, the beamforming functionality of the pre-processing circuitry 254 may be configured to generate multiple beamformed audio signals, where each beamformed signal has a different directional pattern. In some cases, the one or more audio signals 256 may include at least one front-facing beamformed audio signal and/or at least one rear-facing beamformed audio signal. Front-facing beamformed signals may generally attenuate signals coming from behind a wearer more than signals coming from in front of the wearer, while rear-facing beamformed signals may generally attenuate signals coming from in front of the wearer more than signals coming from behind the wearer. The cardioid directional patterns may provide heart-shaped sensitivity patterns with maximum sensitivity in one direction and minimum sensitivity in the opposite direction. The supercardioid and hypercardioid patterns may provide more focused directional sensitivity with different null positions and/or side lobe characteristics compared to cardioid patterns. The dipole patterns may provide bidirectional sensitivity with maximum sensitivity in two opposite directions and minimum sensitivity perpendicular to the main axis.

The pre-processing circuitry 254 may be configured to perform short-time Fourier transformation (STFT) operations to convert short windows of the processed audio signals from time domain to frequency domain representations. The STFT operations may include windowing functions, overlap processing, and/or frequency bin calculations to generate spectral representations of the audio signals. The pre-processing circuitry 254 may also be configured to perform feature extraction operations, which may include mathematical transformations such as magnitude calculations, phase extraction, and/or other spectral feature computations. The normalization operations may include amplitude scaling, dynamic range adjustment, and/or statistical normalization procedures to ensure consistent signal levels and characteristics. The output of the pre-processing circuitry 254 is the one or more audio signals 256, which may include multiple processed audio signals derived from the original microphone inputs through the various processing operations described above.

The neural network circuitry 114 may be configured to receive the one or more audio signals 256 from the pre-processing circuitry 254 and implement one or more neural network layers trained to perform noise reduction based on the one or more audio signals 256. The neural network circuitry 114 may be configured to receive and process the one or more audio signals 256, enabling the neural network layers to analyze spatial and spectral relationships between multiple audio channels simultaneously.

With continued reference to FIG. 2, the neural network layers implemented by the neural network circuitry 114 may have various neural network architectures including recurrent neural networks, vanilla feedforward neural networks, convolutional neural networks, generative adversarial networks, attention-based networks such as transformer architectures, and/or graphical neural networks. The neural network architectures may include an input layer configured to receive the one or more audio signals 256, multiple intermediate layers configured to perform feature extraction and transformation operations, and an output layer configured to generate the one or more neural network outputs 258. The intermediate layers may include multiple neurons or nodes with associated neural network weights that have been trained through machine learning processes to perform noise reduction operations.

In some embodiments, the neural network implemented by the neural network circuitry 114 may be trained to reduce noise. In some embodiments, the neural network implemented by the neural network circuitry 114 may be trained to reduce noise and perform spatial focusing. With further regards to training, training the neural network to perform noise reduction may include obtaining, as input training data, input audio signals containing noise and different types of voice-based audio components. Output audio signals that are versions of the input audio signals with the noise components removed may be determined. Then, masks that, when applied to the input audio signals, result in the output audio signals, may be determined and used as output training data. Based on the input training data and the output training data, the neural network may learn how to output a mask for an audio signal, such that when the mask is applied to (e.g., multiplied by or added to) the audio signal, the resulting audio signal has noise components removed.

In some embodiments, the neural network may be trained to perform both noise reduction and spatial focusing. Performing noise reduction may include generating a mask that, when applied to an audio signal, results in a version of the audio signal with noise components removed. Spatial focusing in addition to noise reduction may include generating the mask such that, when the mask is applied to the audio signal, noise components are removed and each remaining component of the audio signal is weighted by a value depending on its direction-of-arrival (DOA). For example, audio components of the audio signal arriving from in front of the wearer may be weighted more than audio components of the audio signal arriving from behind the wearer. Neural network-based spatial focusing may require the neural network circuitry 114 to receive more than one audio signal.

This description may describe that a neural network is trained to perform a certain action, or to generate an output for use in performing that action. As referred to herein, a neural network may be considered trained to perform a certain action if the neural network performs that action itself, or if it generates output for use in performing that action. Thus, it should be appreciated that a neural network may be considered trained to perform noise reduction even if the neural network itself does not generate a noise-reduced audio signal. If the neural network generates a mask (or generally, an output) configured to generate a noise-reduced audio signal, the neural network may still be considered trained to perform noise reduction. It should also be appreciated that a neural network may be considered trained to perform noise reduction and spatial focusing even if the neural network itself does not generate a noise-reduced and spatially-focused audio signal. If the neural network generates a mask (or generally, an output) configured to be used to generate a noise-reduced and spatially-focused audio signal, the neural network may still be considered trained to perform noise reduction and spatial focusing. Additionally, a neural network may be considered a noise reduction neural network if it generates a noise-reduced signal or if it generates a noise-reducing mask (i.e., a mask that, when applied to an audio signal, results in a noise-reduced version of that audio signal). A neural network may be considered a noise reduction and spatial-focusing neural network if it generates a noise-reduced and spatially-focused signal or if it generates a noise-reducing and spatially-focusing mask (i.e., a mask that, when applied to an audio signal, results in a noise-reduced and spatially-focused version of that audio signal).

The above description has described the neural network circuitry 114 as receiving the one or more audio signals 256. This should be understood to include the neural network circuitry 114 receiving only one audio signal, or receiving one audio signal among other audio signals. In the latter scenario, the neural network may generate a mask (e.g., the mask 358) based on the one audio signal and the other audio signals. However, the mask might only be applied to one of the multiple audio signals. Generally, the neural network circuitry 114 may be configured to receive one or more audio signals. In some embodiments, the one or more audio signals may include one signal. In some embodiments, the one or more audio signals may include two signals. In some embodiments, the one or more audio signals may include three signals. In some embodiments, the one or more audio signals may include four signals. In some embodiments, the one or more audio signals may include more than four signals. In some embodiments, the one or more audio signals may be in the frequency domain. In some embodiments, the one or more audio signals may be in the time domain. In some embodiments, the neural network circuitry 114 may be configured to receive multiple audio signals together (i.e., not one after another). In some embodiments, the neural network circuitry 114 may be configured to process multiple audio signals together (i.e., not one after another).

The neural network circuitry 114 may be configured to generate one or more neural network outputs 258. In some cases, the one or more neural network outputs 258 may include a mask configured to be applied to one of the one or more audio signals 256 to generate an enhanced version of that audio signal. The mask may be a real mask that modifies magnitude characteristics and/or a complex mask that modifies both magnitude and phase characteristics of different frequency components. One of the one or more audio signals 256 may be the specific audio signal to which the mask is applied. This audio signal may be a front-facing audio signal and may also be, for example, a beamformed audio signal having a cardioid or supercardioid directional pattern. The mask may vary with frequency such that when applied to the audio signal through multiplication and/or addition operations, different frequency components of the audio signal may be modified by different real or complex values to achieve noise reduction effects.

The one or more neural network outputs 258 may also include an additive component that may also be referred to as a post-mask correction. The additive component may be configured to be added to the product of the mask and the audio signal to provide further refinement of the audio signal beyond the modifications performed by the mask alone. In some cases, the additive component may be complex, having both magnitude and phase portions, while the mask may be real, having only a magnitude portion. This configuration allows the additive component to modify phase characteristics even when the mask cannot perform phase modifications. The additive component may be configured to perform additional noise reduction and/or other audio enhancement operations that complement the mask-based processing. In some implementations, the neural network circuitry 114 may be configured to directly output audio signals themselves as part of the one or more neural network outputs 258, rather than generating masks and additive components configured to generate output audio signals.

The post-processing circuitry 220 may be configured to receive the one or more neural network outputs 258 from the neural network circuitry 114 and perform various signal processing operations to generate the output audio signal 252. When the one or more neural network outputs 258 include a mask (e.g., the mask 358 described below), the post-processing circuitry 220 may be configured to perform mask application operations by multiplying and/or adding the mask to an audio signal (e.g., a front-facing audio signal as described above). The post-processing circuitry 220 may also be configured to add an additive component to the product of the mask and the audio signal when an additive component is provided as part of the one or more neural network outputs 258. The result of these mask application and additive component operations may be an enhanced audio signal (e.g., one that has reduced noise characteristics compared to the original audio signal).

The post-processing circuitry 220 may be configured to obtain additional signals by performing subtraction operations after mask application, such as subtracting a speech component from the audio signal to obtain a noise component, and/or performing other mathematical operations depending on the specific signal separation requirements. In more detail, the post-processing circuitry 220 may be configured to perform mixing operations that combine two or more audio signals using various weighting and combination techniques. The mixing operations may include signals generated by the post-processing circuitry 220 through mask application and subtraction operations, and may also include one or more of the audio signals 256 received by the neural network circuitry 114. The mixing operations may include application of different weights to different signals through multiplication operations, followed by combination of the weighted results through addition operations. In some cases, the post-processing circuitry 220 may be configured to mix a speech component (e.g., the speech signal 362 described below) and/or a noise component (e.g., the noise signal 364 described below). The mixing may include applying an attenuation factor (e.g., the attenuation factor 370 described below) to the noise component such that the output includes the speech component plus the attenuated noise component, where the attenuation factor may be between 0 and 1 to provide controllable noise reduction levels while maintaining some ambient sound awareness. In some cases, the post-processing circuitry 220 may be configured to perform an equivalent operation by mixing a speech component with one of the audio signals 256, using an attenuation factor applied to the audio signal.

With continued reference to FIG. 2, the post-processing circuitry 220 may be configured to perform additional processing operations including wide-dynamic range compression (WDRC) and/or output calibration. The wide-dynamic range compression may include automatic gain control algorithms, multi-band compression, and/or limiting operations configured to manage the dynamic range of the processed audio signals for comfortable listening levels. The output calibration may include frequency response correction, gain adjustment, and/or impedance matching operations to ensure proper signal levels and characteristics for subsequent output stages or transmission operations. When the pre-processing circuitry 254 has performed STFT operations to convert audio signals to frequency domain, the post-processing circuitry 220 may be configured to perform inverse STFT (iSTFT) operations to convert the processed frequency domain signals back to time domain representations suitable for audio output and/or transmission. The output audio signal 252 generated by the post-processing circuitry 220 may represent the final processed audio result that may be provided to the receiver (e.g., the receiver 106) of the ear-worn device.

The own-voice detection circuitry 116 may be configured to generate an own-voice indication 234 indicating whether the wearer's own voice is present or absent in the audio signals. For example, in some embodiments the indication 234 may be a binary indication (e.g., a digital high signal if own-voice is present or a digital low signal if own-voice is not present). In some embodiments, the indication 234 may take on a range of values (e.g., based on confidence or probability that own-voice is present). The indication 234 may be received by one or more components of the processing circuitry 104, such as the pre-processing circuitry 254, the neural network circuitry 114, and/or the post-processing circuitry 220. Thus, in some embodiments, the pre-processing circuitry 254 may be configured to receive the own-voice indication 234 and perform pre-processing operations based on the own-voice indication 234. For example, the pre-processing circuitry 254 may be configured to perform STFT operations with different length windows based on the own-voice indication 234. In some embodiments, the neural network circuitry 114 may be configured to receive the own-voice indication 234 and perform neural network processing operations based on the own-voice indication 234. For example, the neural network circuitry 114 may be configured to implement different neural networks based on the own-voice indication 234. In some embodiments, the post-processing circuitry 220 may be configured to receive the own-voice indication 234 and perform post-processing operations based on the own-voice indication 234. For example, the own-voice indication 234 may influence gain adjustment, high-pass filtering, wide dynamic range compression, and speech component exclusion. Further details of how processing operations may be affected by whether own-voice is present or not will be provided below.

The own-voice detection circuitry 116 may include digital signal processing circuitry and/or neural network circuitry configured to receive various inputs and generate the own-voice indication 234 based on processing those inputs. In some embodiments, the digital signal processing circuitry may be configured to perform signal analysis operations including correlation analysis, spectral analysis, temporal pattern recognition, and/or statistical processing to identify characteristics indicative of own-voice activity. In some embodiments, the neural network circuitry may be configured to implement one or more neural network layers trained to detect own-voice based on the received inputs through machine learning processes. Further description of inputs to the own-voice detection circuitry 116 may be found below. The own-voice detection circuitry 116 may be configured to process these inputs individually or in combination through fusion techniques to generate the own-voice indication 234 with improved accuracy and robustness across various acoustic environments and operating conditions.

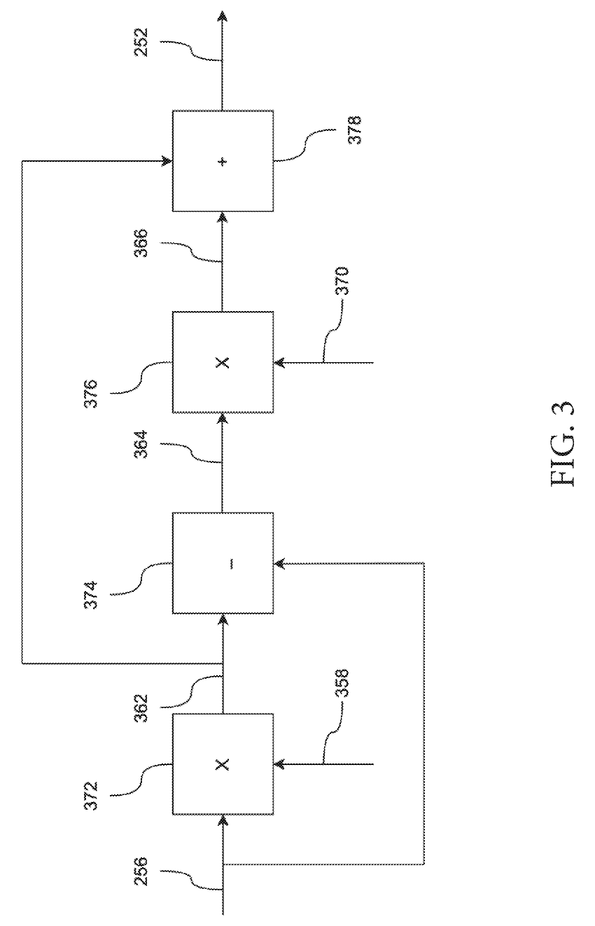

FIG. 3 illustrates signal processing operations that may be performed by the post-processing circuitry 220 to generate the output audio signal 252 from one of the audio signals 256 using a mask 358. The audio signal 256 may be multiplied by the mask 358 using the multiplier 372 to generate a speech component 362. The speech component 362 may represent the portion of the audio signal 256 that corresponds to speech after noise reduction processing. A subtractor 374 may subtract the speech component 362 from the audio signal 256 to generate a noise component 364, which may represent the portion of the audio signal 256 that corresponds to noise or unwanted signals.

The multiplier 376 may multiply the noise component 364 by an attenuation factor 370 to generate an attenuated noise component 366. The attenuation factor 370 may be a value between 0 and 1, where values closer to 0 provide greater noise reduction and values closer to 1 preserve more of the ambient noise for situational awareness. An adder 378 may combine the speech component 362 and the attenuated noise component 366 to generate the output audio signal 252.

The mask 358 may be frequency-dependent, enabling different levels of noise reduction across different frequency bands. The attenuation factor 370 may be adjustable based on user preferences, environmental conditions, or automatic adaptation algorithms to optimize the balance between noise reduction versus ambient sound awareness. For simplicity, FIG. 3 omits any additive components.

In some embodiments, rather than the neural network circuitry 114 outputting a mask configured to generate a speech component, the neural network circuitry 114 may be configured to directly output the speech component 362 itself. In such embodiments, the post-processing circuitry 220 might not perform mask application. In some embodiments, the neural network circuitry 114 may be configured to output more than one mask configured to generate the speech component 362 and the noise component 364. In such embodiments, the post-processing circuitry 220 might not perform subtraction. In some embodiments, rather than the neural network circuitry 114 outputting a mask configured to generate the speech component 362, the neural network circuitry 114 may output a mask configured to generate the noise component 364, and the post-processing circuitry 220 may be configured to use subtraction to generate the speech component 362 using the noise component 364. Generally, the processing circuitry 104 may be configured to separate speech from noise in an audio signal using a neural network implemented by the neural network circuitry 114, and such separation may include obtaining either the speech or the noise of the audio signal (e.g., using a mask or directly).

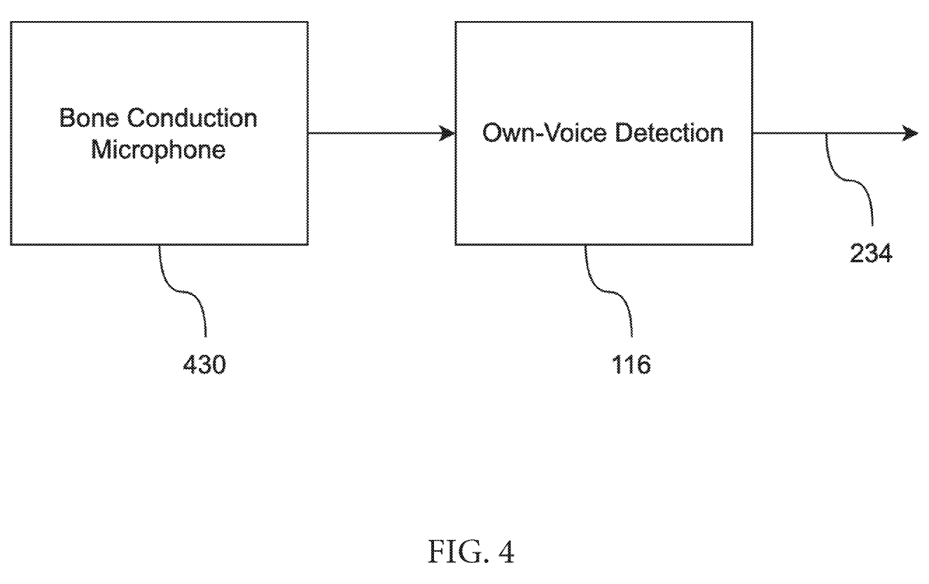

FIG. 4 illustrates the own-voice detection circuitry 116 receiving input from a bone conduction microphone 430 (which may correspond to one or more of the microphones 102), in accordance with certain embodiments described herein. The bone conduction microphone 430 may be configured to detect vibrations transmitted through the wearer’s cranial bones during speech production. These vibrations may carry the unique acoustic characteristics of the wearer’s voice and may be relatively unaffected by external ambient noise or other voices. The bone conduction microphone 430 may be positioned to maintain direct contact with the wearer’s skin or bone, such as near the mastoid bone behind the ear or within the ear canal, where vibrations are most effectively transmitted. The own-voice detection circuitry 116 may be configured to process the captured bone-conducted signals to detect own-voice. The processing steps may include one or more of signal preprocessing techniques, such as filtering and amplification, to enhance the input signal while eliminating noise artifacts caused by motion or environmental interference; pattern recognition algorithms to analyze the spectral and temporal features of the bone-conducted signal and identify the unique voice signature of the wearer; and synchronization with air-conduction microphone data for cross-referencing to ensure that the identified speech originates from the user. Based on the processing, the own-voice detection circuitry 116 may be configured to output the indication 234 of whether own-voice is present or not. It should be appreciated that the bone conduction microphone 430 may be able to provide robust own-voice signals even in noisy environments; however, a bone conduction microphone 430 might not be sufficiently practical in certain types of ear-worn devices such as hearing aids. Accordingly, other methods for own-voice detection, as described below, might be used for such ear-worn devices.

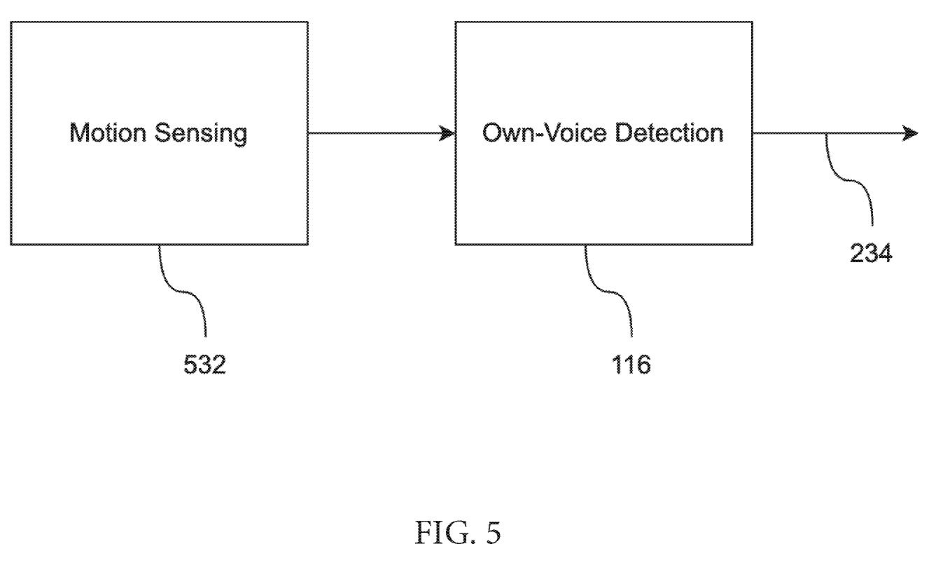

FIG. 5 illustrates the own-voice detection circuitry 116 receiving input from motion sensing circuitry 532, in accordance with certain embodiments described herein. In some embodiments, the motion sensing circuitry 532 may include one or more accelerometers and/or one or more gyroscopes and/or one or more magnetometers (in some embodiments, among other sensors). In some embodiments, the motion sensing circuitry 532 may include an inertial measurement unit (IMU). In some embodiments, the motion sensing circuitry 532 may be configured to detect vibrations and movement generated from the user's speech by sensing mechanical vibrations transmitted through the user's skull and soft tissues during vocalization. These vibrations may exhibit unique patterns corresponding to the wearer’s voice and may be relatively unaffected by ambient noise or external voices. The own-voice detection circuitry 116 may be configured to process the captured motion signals to detect own-voice. The processing steps may include one or more of signal preprocessing techniques, such as filtering and amplification, to remove non-speech-related motion artifacts such as those caused by head movements or external impacts, and to enhance the vibration patterns specific to speech; pattern recognition algorithms to analyze the temporal and spectral characteristics of the motion data to identify the unique vibrational signature of the wearer’s voice; and synchronization with air-conduction microphone data for cross-referencing to ensure that the identified speech originates from the user. Based on the processing, the own-voice detection circuitry 116 may be configured to output the indication 234 of whether own-voice is present or not.

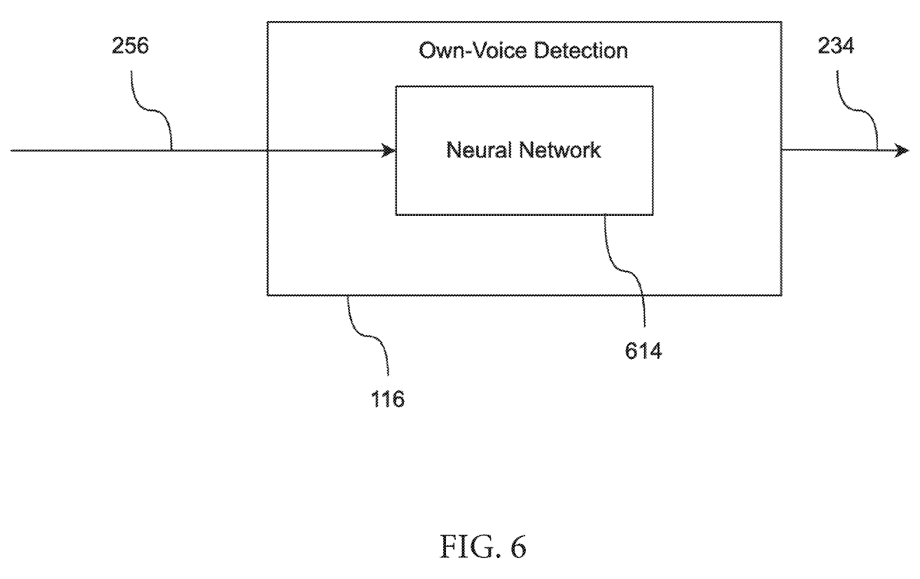

FIG. 6 illustrates the own-voice detection circuitry 116 including neural network circuitry 614, in accordance with certain embodiments described herein. The neural network circuitry 614 may be configured to receive the audio signals 256 and implement a neural network trained to determine whether own-voice is present or not. To train the neural network, training data may include audio signals as input training data and indications of whether the audio signals include own-voice or not as output training data. Based on the neural network processing, the own-voice detection circuitry 116 may be configured to output the indication 234 of whether own-voice is present or not.

In some embodiments, the neural network trained to determine whether own-voice is present or not may be the same as the neural network trained for noise reduction. In such embodiments, the neural network may be trained to output two outputs, the indication 234 (for own-voice detection) and the mask 358 (for noise reduction). In such embodiments, the neural network circuitry 114 and 614 may be the same. In some embodiments, the neural network trained to determine whether own-voice is present or not may be different from the neural network trained for noise reduction.

In some embodiments, the neural network circuitry 614 may be configured to implement a neural network trained to detect voice signatures for own-voice recognition. The wearer may create a personalized voice signature through an enrollment process. In some embodiments, the enrollment process may be performed using a processing device (e.g., a smartphone, tablet, or laptop) that can communicate wirelessly with the ear-worn device. In some embodiments, the enrollment process may include the wearer speaking predetermined phrases or engaging in natural speech while the processing device captures and analyzes acoustic characteristics unique to the wearer's voice. The enrollment process may, for example, extract distinctive voice features including fundamental frequency patterns, formant structures, spectral envelope characteristics, prosodic patterns, and/or other acoustic markers that distinguish the wearer's voice from other speakers. The neural network may be trained to recognize these enrolled voice signature features within incoming audio signals and generate the own-voice indication 234 when the detected voice characteristics match the stored voice signature profile. The enrollment process may be performed during initial device setup, during fitting appointments, and/or may be updated periodically to account for natural changes in the wearer's voice over time due to aging, health conditions, or other factors. In some cases, the neural network may be configured to continuously adapt the stored voice signature based on detected own-voice instances to maintain accurate recognition performance as the wearer's vocal characteristics evolve.

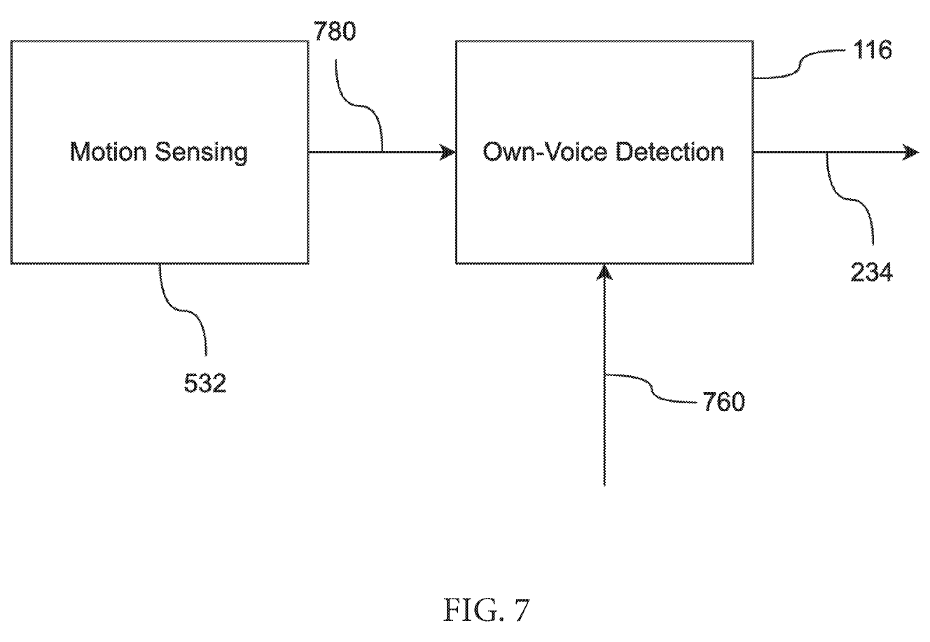

FIG. 7 illustrates the own-voice detection circuitry 116 receiving one or more motion signals 780 from motion sensing circuitry 532 (further description of which may be found above) and one or more post-neural network outputs 760, in accordance with certain embodiments described herein. The one or more motion signals 780 may include signals from one or more accelerometers, one or more gyroscopes, one or more magnetometers, or a combination thereof.

In some embodiments the one or more post-neural network outputs 760 may include the output audio signal 252 (e.g., an enhanced audio signal, which may be a denoised and/or spatially-focused version of an input audio signal). In some embodiments, the one or more post-neural network outputs 760 may include the speech component 362. Generally, in some embodiments the one or more post-neural network outputs 760 may include an output audio signal generated using an output of a neural network (e.g., a mask). When the one or more post-neural network outputs 760 include an audio signal, the own-voice detection circuitry 116 may be configured to perform correlation-based fusion of the one or more motion signals 780 and the one or more post-neural network outputs 760. The fusion approach may leverage the correlation between motion signals and post-model audio signals to provide robust own-voice detection even in noisy environments.

The fusion of the one or more motion signals 780 with one or more post-neural network outputs 760 that include audio signals may provide complementary information that enhances own-voice detection accuracy by leveraging the distinct sensitivity characteristics of each signal type. The one or more motion signals 780 may be sensitive to vibrations generated by the wearer's own voice through bone conduction and tissue transmission, but may also respond to spurious motion artifacts caused by head movements, physical impacts, or other non-speech mechanical disturbances. Simultaneously, audio signals may be sensitive to the wearer's own voice through air conduction pathways, but may also capture background noise, competing voices, and environmental acoustic interference. When the own-voice detection circuitry 116 performs correlation analysis between the one or more motion signals 780 and audio signals included in the one or more post-neural network outputs 760, correlated activity detected in both signal types may provide strong evidence of own-voice presence, as such correlation may indicate that the detected vibrations and acoustic signals originate from the same source—namely, the wearer's vocalization. When the one or more motion signals 780 exhibit activity that does not correlate with activity in the one or more post-neural network outputs 760, such uncorrelated motion activity may indicate spurious head movements or mechanical artifacts rather than own-voice activity, allowing the own-voice detection circuitry 116 to avoid false positive detections that might otherwise result from motion-only analysis. Conversely, when the one or more post-neural network outputs 760 exhibit activity that does not correlate with activity in the one or more motion signals 780, such uncorrelated audio activity may indicate background noise, environmental sounds, or other speakers rather than own-voice activity, allowing the own-voice detection circuitry 116 to avoid false positive detections that might otherwise result from audio-only analysis. The correlation-based fusion approach may therefore provide improved specificity for own-voice detection by analyzing evidence from both motion and audio signal modalities, which may reduce false positive detections caused by either spurious motion artifacts or background acoustic interference while maintaining sensitivity to actual own-voice activity that generates correlated responses in both signal types.

In some embodiments, the own-voice detection circuitry 116 may be configured to implement one or more of the following correlation-based fusion approaches to combine signals from independent sources (e.g., motion signals and audio signals): cross-correlation analysis, coherence analysis in the frequency domain, mutual information techniques, dynamic time warping, canonical correlation analysis, phase-locked loop approaches, adaptive correlation filtering, wavelet coherence analysis, principal component analysis, Kalman filtering, particle filtering approaches, neural networks, statistical correlation tracking (e.g., using sliding window approaches), and/or spectral correlation analysis.

With specific regard to neural network-based fusion, during training of the neural network, training data may include paired audio and motion sensor data as input training data, where the audio data may include processed audio signals downstream of noise reduction processing and the motion data may include accelerometer, gyroscope, and/or magnetometer measurements captured during the same time periods as the audio signals. The output training data may include labels indicating whether own-voice is present or absent in each training sample. The neural network may learn to identify correlation patterns between the audio and motion signals that are characteristic of own-voice activity, enabling the network to distinguish own-voice from other speakers or environmental sounds based on the combined information from both sensor modalities.

The correlation-based fusion approach may benefit from using audio signals downstream of the neural network circuitry 114 rather than upstream signals because downstream signals have undergone noise reduction that isolates speech components while attenuating background noise and/or speech from non-target directions. Audio signals upstream of noise reduction processing may contain significant ambient noise, competing voices, and environmental interference that can mask correlation patterns between motion sensor signals (including accelerometer, gyroscope, and magnetometer signals) and the wearer's own voice, potentially leading to false positive or false negative detections. Thus, the enhanced downstream audio signal may provide more reliable correlation features for own-voice detection algorithms.

In some embodiments, the one or more audio signals included in the one or more post-neural network outputs 760 and the one or more motion signals 780 may be captured at different sample rates, which may require temporal alignment before correlation-based fusion can be performed. The own-voice detection circuitry 116 may be configured to perform sample rate conversion operations to align the temporal characteristics of the audio and motion signals before performing correlation analysis. In some embodiments, the own-voice detection circuitry 116 may be configured to downsample the audio signals to match the sample rate of the motion signals, which may reduce computational complexity while preserving the temporal correlation features needed for own-voice detection.

In some embodiments, the one or more post-neural network outputs 760 that are fused with the one or more motion signals 780 may include non-audio signals, such as a mask (e.g., the mask 358). Indeed, the mask may represent a particularly suitable quantity for fusion with motion signals. For a real mask, the mask values may naturally fall within a range between 0 and 1, where values closer to 1 may indicate higher confidence that speech (but not necessarily own-voice) is present in the corresponding frequency components and values closer to 0 may indicate higher confidence that noise rather than speech is present. For a complex mask, the magnitude of the values may be closer to 0 when there is higher confidence that speech is present and larger than 0 where there is higher confidence that speech is present. The above description of fusion may apply to fusion of non-audio signals as well.

In some embodiments, the one or more post-neural network outputs 760 may include a neural network-generated prediction of own-voice. In other words, the neural network (i.e., implemented by the neural network circuitry 114) may be trained to distinguish between own-voice and other people's voices in the audio signals 256. In some embodiments, the neural network may be configured to distinguish between own-voice and other people's voices using voice signature recognition. In such embodiments, the neural network may be trained to recognize unique acoustic characteristics of the wearer's voice. During an enrollment process, the wearer may provide voice samples that enable the neural network to learn the wearer's personalized voice signature. The neural network may then analyze incoming audio signals to determine whether detected speech matches the enrolled voice signature, generating an own-voice prediction when the acoustic characteristics align with the stored voice profile. Further description of neural network-based voice signature use may be found above.

In some embodiments, the neural network may be configured to distinguish between own-voice and other people's voices using spatial analysis based on multiple microphone inputs. The ear-worn device may include multiple microphones (e.g., the one or more microphones 102) positioned at different locations, and the neural network may be trained to analyze the spatial characteristics of incoming audio signals to determine the direction and position of the speaker relative to the wearer. The neural network may process differences in signal timing, amplitude, and phase between the multiple microphone channels to estimate the spatial origin of detected speech. As an example, when the neural network determines that speech originates from a position directly in front of the wearer, this spatial information may indicate a higher probability that the detected speech represents own-voice rather than speech from other speakers, as the wearer's mouth may be positioned in front of the microphones when the ear-worn device is worn. Thus, the spatial analysis approach may leverage the geometric relationship between the microphone array and the wearer's vocal apparatus to provide directional cues for own-voice detection.

When the one or more post-neural network outputs 760 include a neural network-generated prediction of own-voice, the fusion performed by the own-voice detection circuitry 116 may include combining two (or more) independent predictions to generate a composite own-voice detection prediction. In such embodiments, the own-voice detection circuitry may generate a first prediction indicating a probability that own-voice is present based on analysis of the one or more motion signals 780, while the neural network circuitry 114 may provide a second prediction indicating a probability that own-voice is present based on analysis of audio signals (e.g., the audio signals 256). The own-voice detection circuitry 116 may be configured to combine these independent predictions. For example, when the motion-based prediction indicates a 30% probability that own-voice is present and the audio-based prediction indicates a 10% probability that own-voice is present, the own-voice detection circuitry 116 may generate a composite score that reflects the combined evidence from both sources, such as a 7% probability.

In some embodiments, the effectiveness of motion sensing circuitry 532 for own-voice detection may vary depending on the acoustic environment. In quiet environments, the motion signals generated by the motion sensing circuitry 532 during speech may have relatively low amplitude, and these signals may be susceptible to interference from random noise sources, mechanical vibrations, or other artifacts that can reduce the signal-to-noise ratio of the motion-based own-voice detection. In such quiet conditions, the motion signals corresponding to the wearer's speech may be difficult to distinguish from background motion noise, potentially leading to reduced detection accuracy or reliability.

Conversely, in loud acoustic environments, the wearer may naturally speak with greater vocal effort and intensity, which may result in stronger mechanical vibrations transmitted through the skull and soft tissues. These higher-amplitude vibrations may be more readily detected by the motion sensing circuitry 532, providing a more robust signal for own-voice detection. The increased signal strength in loud environments may improve the signal-to-noise ratio of the motion-based detection, making it more reliable for identifying own-voice activity even when ambient acoustic noise levels are high.

In some embodiments, the own-voice detection circuitry 116 may be configured to adaptively engage or disengage motion-based own-voice detection based on the detected acoustic environment. For example, the processing circuitry 104 may be configured to monitor ambient noise levels using the one or more microphones 102, and the own-voice detection circuitry 116 may be configured to increase reliance on motion sensing circuitry 532 when ambient noise levels exceed a threshold value, while reducing or disabling motion-based detection when ambient noise levels fall below the threshold. This adaptive approach may optimize detection performance by leveraging motion-based detection in environments where it performs well (e.g., loud environments where wearers are likely to speak loudly) while relying on alternative detection methods in environments where motion-based detection may be less reliable (e.g., quiet environments where speech-induced vibrations have lower amplitude).

It should be appreciated that an ear-worn device (e.g., the ear-worn device 100) may include one or more of the bone conduction microphone 430, the motion sensing circuitry 532, and the neural network circuitry 614 configured to implement a neural network trained to determine whether own-voice is present or not. In some embodiments, the own-voice detection circuitry 116 may be configured to output the indication 234 of whether own-voice is present or not based on two or more of the methods described above.

Referring back to FIG. 2, in some embodiments the own-voice detection circuitry 116 may be configured to output the indication 234 of whether own-voice is present or not to the post-processing circuitry 220, and the indication 234 may control operation of the post-

processing circuitry 220 (e.g., whether the post-processing circuitry 220 performs own-voice processing or not). Generally, the post-processing circuitry 220 may be configured to perform signal processing on the speech component (e.g., the speech component 362) and the noise component (e.g., the noise component 364). In some embodiments, such signal processing may include amplification (e.g., as part of wide dynamic range compression (WDRC)) and/or filtering. In some embodiments, the post-processing circuitry 220 may be configured to perform own-voice processing on the speech component if own-voice is present. In some embodiments, the own-voice processing may include applying different gains to the speech component when own-voice is present versus when own-voice is not present. In some embodiments, the post-processing circuitry 220 may include a high-pass filter, and tuning the own-voice gains (i.e., the gains applied to the speech in the audio signal when the wearer of the ear-worn device is talking) may be performed during a fitting by iteratively moving the cutoff frequency of the high-pass filter until own-voice sounds natural to a wearer of the ear-worn device 100. In some embodiments, the post-processing circuitry 220 may be part of WDRC circuitry and may be configured to apply different WDRC gains when own-voice is present versus when own-voice is not present. In such embodiments, the speech component 362 and the noise component 364 may be processed by separate WDRC pipelines including separate level estimators. Further description of separate WDRC pipelines may be found in U.S. Patent No. 11,902,747, titled “Hearing loss amplification that amplifies speech and noise subsignals differently,” and issued on Feb. 13, 2024. In some embodiments, the post-processing circuitry 220 may be configured to exclude the speech component 362 from the output of the post-processing circuitry 220 when own-voice is present. In some embodiments, the post-processing circuitry 220 may be configured to separate out an own-voice signal from non-own-voice signals in the speech component 362 and process the own-voice signal separately from the non-own-voice signals. The separate processing of the own-voice signal may be any of the processing described above. Separating out own-voice from non-own-voice may be performed, for example, by a neural network. In some embodiments, the post-processing circuitry 220 may be configured to process the noise component 364 in the same manner (e.g., with the same gains and/or filter settings and/or WDRC parameters) whether own-voice is present or not. In other words, in some embodiments the own-voice processing might only be applied to the speech component 362 but not to the noise component 364.

Generally, the memory 150 of the ear-worn device 100 may be configured to store own-voice processing parameters and non-own-voice processing parameters. The processing circuitry 104 may be configured to separate speech from noise in an audio signal using a neural network implemented by the neural network circuitry 114, as described above. The own-voice detection circuitry 116 may be configured to determine whether a wearer of the ear-worn device 100 is talking, as described above. The processing circuitry 104 may be configured to process (e.g., using circuitry downstream of the neural network circuitry 114, such as the post-processing circuitry 220), if the wearer of the ear-worn device 100 is talking, at least the speech in the audio signal (e.g., the speech component 362) using the own-voice processing parameters; and process, if the wearer of the ear-worn device 100 is not talking, at least the speech in the audio signal using the non-own-voice processing parameters. Differential processing for own-voice versus non-own-voice is described above.

While the above description has described performing own-voice processing on speech but not noise in an audio signal, because the noise in an audio signal may be significantly attenuated as a result of the neural network circuitry 114’s operation, processing both the speech and the noise in the audio signal using the own-voice processing parameters might not result in degraded performance. Thus, in some embodiments, the processing circuitry 104 may be configured to process just the speech (e.g., the speech component 362), but not the noise (e.g., the noise component 364) in an audio signal using own-voice processing parameters. In some embodiments, the processing circuitry 104 may be configured to process both the speech and the noise in an audio signal using own-voice processing parameters. As described above, the own-voice and non-own-voice processing parameters may include, as non-limiting examples, parameters for gains, low-pass filtering cutoff frequencies, and/or WDRC.

In some embodiments, neural network processing operations may be affected by whether own-voice is present or not. This may involve adapting the operation of the neural network circuitry 114 (e.g., by changing the neural network implemented and/or by changing the number of neural network-based results used for generating each frame of output data), and may also affect operation of the pre-processing circuitry 254 (e.g., by changing the length of the STFT window). Thus, the own-voice detection circuitry 116 may be configured to output the indication 234 of whether own-voice is present or not to the neural network circuitry 114 and/or the pre-processing circuitry 254, and the indication 234 may control operation of the neural network circuitry 114 and/or the pre-processing circuitry 254.

In more detail, own-voice detection may impact both the neural network processing and the STFT window size. When own-voice is detected, the processing circuitry 104 may be configured to switch to a lower-latency configuration, which may involve using a shorter STFT frame size, disabling or switching to a simpler neural network (or a specific "head" of a neural network with a shorter latency), and/or using a fewer number of neural network-based results to generate each frame of output data, to minimize processing delay. This low-latency mode may be beneficial because a higher latency when the wearer is speaking could cause an uncomfortable and disorienting lag between bone conduction and the processed audio, as well as a disconnect between the wearer's vocal intention and the auditory feedback, potentially resulting in an echo effect. Conversely, when own-voice is not detected, the processing circuitry 104 may be configured to switch to a higher-latency configuration, allowing for a longer STFT frame size, switching to a more complex neural network (or a specific "head" of a neural network with a longer latency), and/or using a larger number of neural network-based results to generate each frame of output data. Longer latency may help the neural network to "look farther into the future" with more data to produce higher quality environmental audio. Further description of latency switching may be found in U.S. Provisional Patent Application No. 63/722,619, filed Jan. 20, 2024, titled "Switching Latency in Ear-Worn Devices Implementing Neural Networks;" U.S. Provisional Patent Application No. 63/738,381, filed Dec. 23, 2024, titled "Switching Latency in Ear-Worn Devices Implementing Neural Networks;" U.S. Provisional Patent Application No. 63/858,581, filed Aug. 6, 2025, titled "Switching Latency in Ear-Worn Devices Implementing Neural Networks;" and U.S. Patent Application No. 19/394,655, filed Nov. 19, 2025, titled "Switching Latency in Ear-Worn Devices Implementing Neural Networks;” each of which is incorporated by reference herein in its entirety.

In some embodiments where the own-voice detection circuitry 116 uses the one or more post-neural network outputs 760 for own-voice detection, there may be two distinct processing configurations that affect how the own-voice indication 234 influences audio signal processing. In a first configuration, the own-voice detection may affect processing downstream of the post-neural network output generation. In this configuration, the own-voice detection circuitry 116 may analyze the one or more post-neural network outputs 760 to determine whether own-voice is present, and the resulting own-voice indication 234 may be used to control processing operations performed by the post-processing circuitry 220. In such cases, the same audio signals 256 that were used to generate the one or more post-neural network outputs 760 may be affected by the own-voice detection results. For example, the post-processing circuitry 220 may apply different gain settings, filtering parameters, or mixing ratios to the speech component 362 and noise component 364 based on the own-voice indication 234 derived from those same audio signals 256. This configuration may enable the system to apply own-voice processing to the current audio frame or processing window based on own-voice characteristics detected within that same frame.

In a second configuration, the own-voice detection may affect processing upstream of the post-neural network output generation. In this configuration, the own-voice detection circuitry 116 may analyze the one or more post-neural network outputs 760 from a current processing cycle to determine whether own-voice is present, but the resulting own-voice indication 234 may be used to control processing operations performed by the neural network circuitry 114 and/or the pre-processing circuitry 254 for subsequent audio processing cycles. In such cases, the own-voice detection might only affect audio signals received subsequently to the audio signals 256 that were used to generate the one or more post-neural network outputs 760 used for the own-voice detection. For example, the neural network circuitry 114 may switch to a different neural network configuration or the pre-processing circuitry 254 may adjust STFT window parameters for processing future audio frames based on own-voice detection results from previous audio frames. This configuration may introduce a processing delay between own-voice detection and the application of own-voice processing parameters,

Deploying audio enhancement techniques may introduce delays between when a sound is emitted by the sound source and when the noise-reduced sound is output to a user. For example, such techniques may introduce a delay between when a speaker speaks and when a listener hears the noise-reduced speech. During in-person communication, long latencies can create the perception of an echo as both the original sound and the noise-reduced version of the sound are played back to the listener. Additionally, long latencies can interfere with how the listener processes incoming sound due to the disconnect between visual cues (e.g., moving lips) and the arrival of the associated sound. To attain tolerable latencies when implementing a neural network on an ear-worn device, the ear-worn device may need to be capable of performing billions of operations per second. To address power issues with such demanding requirements, neural network circuitry (e.g., the neural network circuitry 114, the neural network circuitry 614, and in some embodiments, other circuitry as well), may be implemented on a chip in the ear-worn device 100. Thus, in some embodiments, some or all of the processing circuitry 104 (including some or all of any of the neural network circuitry 114, and/or some or all of the neural network circuitry 614 when present) may be implemented on a single same chip (i.e., a single semiconductor die or substrate) in the ear-worn device 100. Further description of chips incorporating (in some embodiments, among other elements) neural network circuitry for use in ear-worn devices may be found in U.S. Patent No. 11,886,974, entitled “Neural Network Chip for Ear-Worn Device,” issued Jan. 30, 2024, which is incorporated by reference herein in its entirety, as well as below.

The neural network circuitry described herein (e.g., the neural network circuitry 114, the neural network circuitry 614) may include circuitry configured to perform operations necessary for computing the output of a neural network layer. One such operation may be a matrix-vector multiplication. In some embodiments, neural network circuitry may include multiple identical tiles on the chip, each including multiple multiply-and-accumulate circuits configured to perform intermediate computations of a matrix-vector multiplication in parallel and then compute results of the intermediate computations into a final result. Each tile may additionally include memory configured to store neural network weights, registers configured to store input activation elements, and routing circuitry configured to facilitate communication of status and data between tiles. Other types of circuitry configured to perform processing described herein may be implemented as digital processing circuitry on the chip. In some embodiments, such digital processing circuitry may use a SIMD (single instruction multiple data) architecture. Thus, the chip may include the tiles and digital processing circuitry described above. In some embodiments, for a model having up to 10M 8-bit weights, and when operating at 100 GOPs/sec on time series data, the chip may achieve power efficiency of 4 GOPs/milliwatt, measured at 40 degrees Celsius, when the chip uses supply voltages between 0.5-1.8V, and when the chip is performing operations without idling. In some embodiments, in addition to such a chip, the ear-worn device 100 may include a digital signal processor configured to perform other processing operations.

The above description has described two neural network circuitries, the neural network circuitry 114 and 614. In some embodiments, these may be the same circuitry, but configured at different times with different parameters (e.g., neural network weights) such that the same circuitry may implement different neural networks. As described above, in some embodiments these may be the same circuitry and one neural network may be implemented both for detecting own-voice and for noise reduction.

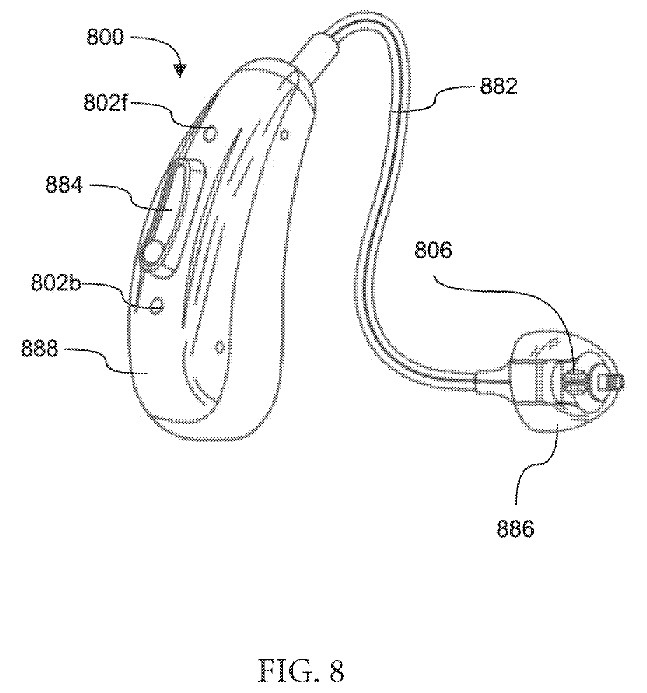

FIG. 8 illustrates a hearing aid 800, in accordance with certain embodiments described herein. The hearing aid 800 may be an example of the ear-worn device 100. The hearing aid 800 is a receiver-in-canal (RIC) (also referred to as a receiver-in-the-ear (RITE)) type of hearing aid. However, any other type of hearing aid (e.g., behind-the-ear, in-the-ear, in-the-canal, completely-in-canal, open fit, etc.) may also be used. The hearing aid includes a body 888, a receiver wire 882, a receiver 806 (which may correspond to the receiver 106), and a dome 886. The body 888 is coupled to the receiver wire 882 and the receiver wire 882 is coupled to the receiver 806. The dome 886 is placed over the receiver 806. The body 888 includes a front microphone 802f, a back microphone 802b, and a user input device 884. (The front microphone 802f and the back microphone 802b may correspond to the one or more microphones 102). The body 888 additionally includes circuitry (e.g., any of the circuitry described above, aside from the receiver 806) not illustrated in FIG. 8. When the hearing aid 800 is worn, the front microphone 802f may be closer to the front of the wearer and the back microphone 802b may be closer to the back of the wearer. The front microphone 802f and the back microphone 802b may be configured to receive sound signals and generate audio signals based on the sound signals. The user input device 884 may be configured to control certain functions of the hearing aid 800, such as switching modes. The receiver wire 882 may be configured to transmit audio signals from the body 888 to the receiver 806. The receiver 806 may be configured to receive audio signals (i.e., those audio signals generated by the body 888 and transmitted by the receiver wire 882) and generate sound signals based on the audio signals. The dome 886 may be configured to fit tightly inside the wearer’s ear and direct the sound signal produced by the receiver 806 into the ear canal of the wearer.

In some embodiments, the length of the body 888 may be equal to 2 cm, equal to 5 cm, or between 2 and 5 cm in length. In some embodiments, the weight of the hearing aid 800 may be less than 4.5 grams. In some embodiments, the spacing between the microphones may be equal to 5 mm, equal to 12 mm, or between 5 and 12 mm. In some embodiments, the body 888 may include a battery (not visible in FIG. 8), such as a lithium ion rechargeable coin cell battery.

This disclosure includes, at least, the following examples:

Example A1 is directed to an ear-worn device comprising processing circuitry comprising neural network circuitry, and wherein the processing circuitry is configured to separate speech from noise in an audio signal using a neural network implemented by the neural network circuitry; own-voice detection circuitry configured to determine whether a wearer of the ear-worn device is talking; and wherein the processing circuitry is configured to apply, if the wearer of the ear-worn device is talking, own-voice processing to the speech in the audio signal but not to the noise in the audio signal; and a receiver configured to play back an output of the processing circuitry as sound into an ear of the wearer..

Example A2 is directed to the ear-worn device of example A1, wherein the ear-worn further comprises a bone conduction microphone; and the own-voice detection circuitry is configured to determine whether the wearer of the ear-worn device is talking using the bone conduction microphone.

Example A3 is directed to the ear-worn device of any of examples A1-A2, wherein the ear-worn further comprises motion sensing circuitry; and the own-voice detection circuitry is configured to determine whether the wearer of the ear-worn device is talking using the motion sensing circuitry.

Example A4 is directed to the ear-worn device of any of examples A1-A3, wherein the own-voice detection circuitry comprises second neural network circuitry, and the own-voice detection circuitry is configured to determine whether the wearer of the ear-worn device is talking using a neural network implemented by the second neural network circuitry.

Example A5 is directed to the ear-worn device of any of examples A1-A4, wherein the own-voice detection circuitry is configured to output a binary indication of whether the wearer of the ear-worn device is talking.

Example A6 is directed to the ear-worn device of any of examples A1-A5, wherein the processing circuitry is configured, when applying the own-voice processing to the speech in the audio signal, to apply different gains to the speech in the audio signal when the wearer of the ear-worn device is talking versus when the wearer of the ear-worn device is not talking.

Example A7 is directed to the ear-worn device of example A6, wherein the processing circuitry comprises a high-pass filter, and tuning the gains applied to the speech in the audio signal when the wearer of the ear-worn device is talking is performed during a fitting by iteratively moving a cutoff frequency of the high-pass filter.

Example A8 is directed to the ear-worn device of example A6, wherein the processing circuitry is configured, when applying the different gains to the speech in the audio signal when the wearer of the ear-worn device is talking versus when the wearer of the ear-worn device is not talking, to apply different wide dynamic range compression (WDRC) gains to the speech in the audio signal when the wearer of the ear-worn device is talking versus when the wearer of the ear-worn device is not talking.

Example A9 is directed to the ear-worn device of example A8, wherein the processing circuitry comprises separate WDRC pipelines for processing the speech in the audio signal and for processing the noise in the audio signal.

Example A10 is directed to the ear-worn device of any of examples A1-A9, wherein the ear-worn device is configured to exclude the speech from an output of the processing circuitry when the wearer of the ear-worn device is talking.

Example A11 is directed to the ear-worn device of any of examples A1-A9, wherein the processing circuitry is configured to separate out own-voice from non-own-voice in the speech of the audio signal; and apply the own-voice processing to the own-voice in the speech of the audio signal but not to the non-own-voice in the speech of the audio signal.

Example A12 is directed to the ear-worn device of any of examples A1-A11, wherein the processing circuitry is configured to apply same gains to the noise in the audio signal whether the wearer of the ear-worn device is talking or not.

Example A13 is directed to the ear-worn device of example A1, wherein the processing circuitry is configured to switch to a lower-latency configuration when the wearer of the ear-worn device is talking and to a higher-latency configuration when the wearer of the ear-worn device is not talking.

Example A14 is directed to the ear-worn device of example A13, wherein the processing circuitry comprises pre-processing circuitry configured to perform short-time Fourier transformation (STFT) operations, and wherein switching to the lower-latency configuration comprises using a first STFT frame size and switching to the higher-latency configuration comprises using a second STFT frame size longer than the first STFT frame size.

Example A15 is directed to the ear-worn device of example A13, wherein switching to the lower-latency configuration comprises the neural network circuitry implementing a first neural network and switching to the higher-latency configuration comprises the neural network circuitry implementing a second neural network more complex than the first neural network.

Example A16 is directed to the ear-worn device of example A13, wherein switching to the lower-latency configuration comprises the neural network circuitry implementing a specific head of a neural network with a first latency and switching to the higher-latency configuration comprises the neural network circuitry implementing a specific head of the neural network with a second latency longer than the first latency.

Example A17 is directed to the ear-worn device of example A13, wherein switching to the lower-latency configuration comprises using a first number of neural network-based results to generate each frame of output data and switching to the higher-latency configuration comprises using a second number of neural network-based results to generate each frame of output data, and the second number is larger than the first number.

Example B1 is directed to an ear-worn device, comprising memory configured to store own-voice processing parameters and non-own-voice processing parameters; processing circuitry comprising neural network circuitry, and wherein the processing circuitry is configured to separate speech from noise in an audio signal using a neural network implemented by the neural network circuitry; own-voice detection circuitry configured to determine whether a wearer of the ear-worn device is talking; and post-processing circuitry downstream of the neural network circuitry configured to process, if the wearer of the ear-worn device is talking, at least the speech in the audio signal using the own-voice processing parameters; and process, if the wearer of the ear-worn device is not talking, at least the speech in the audio signal using the non-own-voice processing parameters; and a receiver configured to play back an output of the processing circuitry as sound into an ear of the wearer.

Example B2 is directed to the ear-worn device of example B1, wherein the own-voice processing parameters and the non-own-voice processing parameters comprise parameters for gains, low-pass filtering cutoff frequencies, and/or WDRC.

Example B3 is directed to the ear-worn device of any of examples B1-B2, wherein the post-processing circuitry is configured to process, if the wearer of the ear-worn device is talking, the speech in the audio signal but not noise in the audio signal using the own-voice processing parameters.

Example B4 is directed to the ear-worn device of any of examples B1-B2, wherein the post-processing circuitry is configured to process, if the wearer of the ear-worn device is talking, the speech in the audio signal and noise in the audio signal using the own-voice processing parameters.

Example B5 is directed to the ear-worn device of any of examples B1-B4, wherein the ear-worn further comprises a bone conduction microphone; and the own-voice detection circuitry is configured to determine whether the wearer of the ear-worn device is talking using the bone conduction microphone.

Example B6 is directed to the ear-worn device of any of examples B1-B5, wherein the ear-worn further comprises motion sensing circuitry; and the own-voice detection circuitry is configured to determine whether the wearer of the ear-worn device is talking using the motion sensing circuitry.

Example B7 is directed to the ear-worn device of any of examples B1-B6, wherein the own-voice detection circuitry comprises second neural network circuitry, and the own-voice detection circuitry is configured to determine whether the wearer of the ear-worn device is talking using a neural network implemented by the second neural network circuitry.

Example B8 is directed to the ear-worn device of any of examples B1-B7, wherein the own-voice detection circuitry is configured to output a binary indication of whether the wearer of the ear-worn device is talking.

Example B9 is directed to the ear-worn device of any of examples B1-B8, wherein the post-processing circuitry is configured to apply different gains to the speech in the audio signal when the wearer of the ear-worn device is talking versus when the wearer of the ear-worn device is not talking.

Example B10 is directed to the ear-worn device of example B9, wherein the post-processing circuitry comprises a high-pass filter, and tuning the gains applied to the speech in the audio signal when the wearer of the ear-worn device is talking is performed during a fitting by iteratively moving a cutoff frequency of the high-pass filter.

Example B11 is directed to the ear-worn device of example B9, wherein the post-processing circuitry is configured, when applying the different gains to the speech in the audio signal when the wearer of the ear-worn device is talking versus when the wearer of the ear-worn device is not talking, to apply different wide dynamic range compression (WDRC) gains to the speech in the audio signal when the wearer of the ear-worn device is talking versus when the wearer of the ear-worn device is not talking.

Example B12 is directed to the ear-worn device of example B11, wherein the post-processing circuitry comprises separate WDRC pipelines for processing the speech in the audio signal and for processing the noise in the audio signal.

Example B13 is directed to the ear-worn device of any of examples B1-B12, wherein the ear-worn device is configured to exclude the speech from an output of the processing circuitry when the wearer of the ear-worn device is talking.

Example B14 is directed to the ear-worn device of any of examples B1-B12, wherein the processing circuitry is configured to separate out own-voice from non-own-voice in the speech of the audio signal; and the post-processing circuitry is configured to apply the own-voice processing to the own-voice in the speech of the audio signal but not to the non-own-voice in the speech of the audio signal.

Example C1 is directed to an ear-worn device comprising motion sensing circuitry configured to generate one or more motion signals; processing circuitry comprising neural network circuitry configured to implement a neural network and generate one or more post-neural network outputs based on one or more audio signals received by the processing circuitry; and own-voice detection circuitry configured to receive the one or more post-neural network outputs and the one or more motion signals; and perform fusion of the one or more post-neural network outputs and the one or more motion signals to determine whether a wearer of the ear-worn device is talking; and a receiver configured to play back an output of the processing circuitry as sound into an ear of the wearer.

Example C2 is directed to the ear-worn device of example C1, wherein the processing circuitry is configured to apply, if the wearer of the ear-worn device is talking, own-voice processing to speech in the one or more audio signals but not to noise in the one or more audio signals.

Example C3 is directed to the ear-worn device of example C2, wherein the processing circuitry is configured, when applying the own-voice processing to the speech in the one or more audio signals, to apply different gains to the speech in the one or more audio signals when the wearer of the ear-worn device is talking versus when the wearer of the ear-worn device is not talking.

Example C4 is directed to the ear-worn device of example C3, wherein the processing circuitry comprises a high-pass filter, and tuning the gains applied to the speech in the one or more audio signals when the wearer of the ear-worn device is talking is performed during a fitting by iteratively moving a cutoff frequency of the high-pass filter.

Example C5 is directed to the ear-worn device of example C3, wherein the processing circuitry is configured, when applying the different gains to the speech in the one or more audio signals when the wearer of the ear-worn device is talking versus when the wearer of the ear-worn device is not talking, to apply different wide dynamic range compression (WDRC) gains to the speech in the one or more audio signals when the wearer of the ear-worn device is talking versus when the wearer of the ear-worn device is not talking.

Example C6 is directed to the ear-worn device of example C5, wherein the processing circuitry comprises separate WDRC pipelines for processing the speech in the one or more audio signals and for processing noise in the one or more audio signals.

Example C7 is directed to the ear-worn device of any of examples C1-C6, wherein the ear-worn device is configured to exclude speech from an output of the processing circuitry when the wearer of the ear-worn device is talking.

Example C8 is directed to the ear-worn device of example C3, wherein the processing circuitry is configured to separate out own-voice from non-own-voice in the speech of the one or more audio signals; and apply the own-voice processing to the own-voice in the speech of the one or more audio signals but not to the non-own-voice in the speech of the one or more audio signals.

Example C9 is directed to the ear-worn device of any of examples C2-C8, wherein the processing circuitry is configured to apply same gains to noise in the one or more audio signals whether the wearer of the ear-worn device is talking or not.

Example C10 is directed to the ear-worn device of example C1, further comprising memory configured to store own-voice processing parameters and non-own-voice processing parameters, wherein the processing circuitry is configured to process, if the wearer of the ear-worn device is talking, at least speech in the one or more audio signals using the own-voice processing parameters; and process, if the wearer of the ear-worn device is not talking, at least the speech in the one or more audio signals using the non-own-voice processing parameters.

Example C11 is directed to the ear-worn device of example C10, wherein the own-voice processing parameters and the non-own-voice processing parameters comprise parameters for gains, low-pass filtering cutoff frequencies, and/or WDRC.

Example C12 is directed to the ear-worn device of example C10, wherein the processing circuitry is configured to process, if the wearer of the ear-worn device is talking, the speech in the one or more audio signals but not noise in the one or more audio signals using the own-voice processing parameters.

Example C13 is directed to the ear-worn device of example C10, wherein the processing circuitry is configured to process, if the wearer of the ear-worn device is talking, the speech in the one or more audio signals and noise in the one or more audio signals using the own-voice processing parameters.

Example C14 is directed to the ear-worn device of example C1, wherein the processing circuitry is configured to switch to a lower-latency configuration when the wearer of the ear-worn device is talking and to a higher-latency configuration when the wearer of the ear-worn device is not talking.

Example C15 is directed to the ear-worn device of example C14, wherein the processing circuitry comprises pre-processing circuitry configured to perform short-time Fourier transformation (STFT) operations, and wherein switching to the lower-latency configuration comprises using a first STFT frame size and switching to the higher-latency configuration comprises using a second STFT frame size longer than the first STFT frame size.

Example C16 is directed to the ear-worn device of example C14, wherein switching to the lower-latency configuration comprises the neural network circuitry implementing a first neural network and switching to the higher-latency configuration comprises the neural network circuitry implementing a second neural network more complex than the first neural network.

Example C17 is directed to the ear-worn device of example C14, wherein switching to the lower-latency configuration comprises the neural network circuitry implementing a specific head of a neural network with a first latency and switching to the higher-latency configuration comprises the neural network circuitry implementing a specific head of the neural network with a second latency longer than the first latency.

Example C18 is directed to the ear-worn device of example C14, wherein switching to the lower-latency configuration comprises using a first number of neural network-based results to generate each frame of output data and switching to the higher-latency configuration comprises using a second number of neural network-based results to generate each frame of output data, and the second number is larger than the first number.

Example C19 is directed to the ear-worn device of example C1, wherein the one or more motion signals comprise signals from one or more accelerometers, one or more gyroscopes, one or more magnetometers, or a combination thereof.

Example C20 is directed to the ear-worn device of example C1, wherein the one or more post-neural network outputs comprise an enhanced audio signal generated using an output of the neural network.

Example C21 is directed to the ear-worn device of example C20, wherein the enhanced audio signal comprises a denoised version of an input audio signal, a spatially-focused version of an input audio signal, or both.

Example C22 is directed to the ear-worn device of example C1, wherein the one or more post-neural network outputs comprise a speech component separated from noise in an input audio signal.

Example C23 is directed to the ear-worn device of example C1, wherein the one or more post-neural network outputs comprise a mask configured to be applied to an input audio signal.

Example C24 is directed to the ear-worn device of example C1, wherein the own-voice detection circuitry is configured to perform correlation-based fusion of the one or more motion signals and the one or more post-neural network outputs.

Example C25 is directed to the ear-worn device of example C24, wherein the correlation-based fusion comprises one or more of cross-correlation analysis, coherence analysis in a frequency domain, mutual information techniques, dynamic time warping, canonical correlation analysis, phase-locked loop approaches, adaptive correlation filtering, wavelet coherence analysis, principal component analysis, Kalman filtering, particle filtering approaches, neural network-based fusion, statistical correlation tracking, or spectral correlation analysis.

Example C26 is directed to the ear-worn device of example C1, wherein the own-voice detection circuitry comprises second neural network circuitry configured to implement a fusion neural network trained to identify correlation patterns between the one or more motion signals and the one or more post-neural network outputs.

Example C27 is directed to the ear-worn device of example C26, wherein the fusion neural network is trained using paired audio and motion sensor data as input training data and labels indicating whether own-voice is present or absent as output training data.

Example C28 is directed to the ear-worn device of example C1, wherein the own-voice detection circuitry is configured to perform sample rate conversion operations to align temporal characteristics of the one or more motion signals and the one or more post-neural network outputs before performing fusion.

Example C29 is directed to the ear-worn device of example C28, wherein the own-voice detection circuitry is configured to downsample audio signals included in the one or more post-neural network outputs to match a sample rate of the one or more motion signals.

Example C30 is directed to the ear-worn device of example C1, wherein the one or more post-neural network outputs comprise a neural network-generated prediction of own-voice.

Example C31 is directed to the ear-worn device of example C30, wherein the neural network circuitry is configured to distinguish between own-voice and other speakers using voice signature recognition.

Example C32 is directed to the ear-worn device of example C31, wherein the neural network circuitry is configured to learn a personalized voice signature of the wearer during an enrollment process.

Example C33 is directed to the ear-worn device of example C30, wherein the neural network circuitry is configured to distinguish between own-voice and other speakers using spatial analysis based on multiple microphone inputs.

Example C34 is directed to the ear-worn device of example C33, wherein the neural network circuitry is configured to analyze differences in signal timing, amplitude, and phase between multiple microphone channels to estimate a spatial origin of detected speech.

Example C35 is directed to the ear-worn device of example C30, wherein the own-voice detection circuitry is configured to combine a first prediction based on the one or more motion signals and a second prediction based on the neural network-generated prediction to generate a composite own-voice detection prediction.

Example C36 is directed to the ear-worn device of example C1, wherein the own-voice detection circuitry is configured to adaptively engage or disengage motion-based own-voice detection based on a detected acoustic environment.

Example C37 is directed to the ear-worn device of example C36, wherein the processing circuitry is configured to monitor ambient noise levels, and the own-voice detection circuitry is configured to increase reliance on the motion sensing circuitry when ambient noise levels exceed a threshold value.

Example C38 is directed to the ear-worn device of example C36, wherein the own-voice detection circuitry is configured to reduce or disable motion-based detection when ambient noise levels fall below a threshold value.

Example D1 is directed to an ear-worn device comprising processing circuitry comprising neural network circuitry, and wherein the processing circuitry is configured to separate speech from noise in an audio signal using a neural network implemented by the neural network circuitry; own-voice detection circuitry configured to determine whether a wearer of the ear-worn device is talking; and wherein the processing circuitry is configured to switch to a lower-latency configuration when the wearer of the ear-worn device is talking and to a higher-latency configuration when the wearer of the ear-worn device is not talking; and a receiver configured to play back an output of the processing circuitry as sound into an ear of the wearer.

Example D2 is directed to the ear-worn device of example D1, wherein the processing circuitry comprises pre-processing circuitry configured to perform short-time Fourier transformation (STFT) operations, and wherein switching to the lower-latency configuration comprises using a first STFT frame size and switching to the higher-latency configuration comprises using a second STFT frame size longer than the first STFT frame size.

Example D3 is directed to the ear-worn device of example D1, wherein switching to the lower-latency configuration comprises the neural network circuitry implementing a first neural network and switching to the higher-latency configuration comprises the neural network circuitry implementing a second neural network more complex than the first neural network.

Example D4 is directed to the ear-worn device of example D1, wherein switching to the lower-latency configuration comprises the neural network circuitry implementing a specific head of a neural network with a first latency and switching to the higher-latency configuration comprises the neural network circuitry implementing a specific head of the neural network with a second latency longer than the first latency.

Example D5 is directed to the ear-worn device of example D1, wherein switching to the lower-latency configuration comprises using a first number of neural network-based results to generate each frame of output data and switching to the higher-latency configuration comprises using a second number of neural network-based results to generate each frame of output data, and the second number is larger than the first number.

Having described several embodiments of the techniques in detail, various modifications and improvements will readily occur to those skilled in the art. Such modifications and improvements are intended to be within the spirit and scope of the invention. Accordingly, the foregoing description is by way of example only, and is not intended as limiting. For example, any components described above may comprise hardware, software or a combination of hardware and software.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

The terms “approximately” and “about” may be used to mean within ±20% of a target value in some embodiments, within ±10% of a target value in some embodiments, within ±5% of a target value in some embodiments, and yet within ±2% of a target value in some embodiments. The terms “approximately” and “about” may include the target value.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

Having described above several aspects of at least one embodiment, it is to be appreciated various alterations, modifications, and improvements will readily occur to those skilled in the art. Such alterations, modifications, and improvements are intended to be objects of this disclosure. Accordingly, the foregoing description and drawings are by way of example only.

1. An ear-worn device comprising:
motion sensing circuitry configured to generate one or more motion signals;
processing circuitry comprising:
neural network circuitry configured to implement a neural network and generate one or more post-neural network outputs based on one or more audio signals received by the processing circuitry; and
own-voice detection circuitry configured to:
receive the one or more post-neural network outputs and the one or more motion signals; and
perform fusion of the one or more post-neural network outputs and the one or more motion signals to determine whether a wearer of the ear-worn device is talking; and
a receiver configured to play back an output of the processing circuitry as sound into an ear of the wearer.

2. The ear-worn device of claim 1, wherein the processing circuitry is configured to apply, if the wearer of the ear-worn device is talking, own-voice processing to speech in the one or more audio signals but not to noise in the one or more audio signals.

3. The ear-worn device of claim 2, wherein the processing circuitry is configured, when applying the own-voice processing to the speech in the one or more audio signals, to apply different gains to the speech in the one or more audio signals when the wearer of the ear-worn device is talking versus when the wearer of the ear-worn device is not talking.

4. The ear-worn device of claim 3, wherein the processing circuitry is configured, when applying the different gains to the speech in the one or more audio signals when the wearer of the ear-worn device is talking versus when the wearer of the ear-worn device is not talking, to apply different wide dynamic range compression (WDRC) gains to the speech in the one or more audio signals when the wearer of the ear-worn device is talking versus when the wearer of the ear-worn device is not talking.

5. The ear-worn device of claim 1, wherein the ear-worn device is configured to exclude speech from the output of the processing circuitry when the wearer of the ear-worn device is talking.

6. The ear-worn device of claim 1, further comprising memory configured to store own-voice processing parameters and non-own-voice processing parameters, wherein the processing circuitry is configured to:
process, if the wearer of the ear-worn device is talking, at least speech in the one or more audio signals using the own-voice processing parameters; and
process, if the wearer of the ear-worn device is not talking, at least the speech in the one or more audio signals using the non-own-voice processing parameters.

7. The ear-worn device of claim 6, wherein the own-voice processing parameters and the non-own-voice processing parameters comprise parameters for gains, low-pass filtering cutoff frequencies, and/or WDRC.

8. The ear-worn device of claim 6, wherein the processing circuitry is configured to process, if the wearer of the ear-worn device is talking, the speech in the one or more audio signals but not noise in the one or more audio signals using the own-voice processing parameters.

9. The ear-worn device of claim 1, wherein the processing circuitry is configured to switch to a lower-latency configuration when the wearer of the ear-worn device is talking and to a higher-latency configuration when the wearer of the ear-worn device is not talking.

10. The ear-worn device of claim 9, wherein the processing circuitry comprises pre-processing circuitry configured to perform short-time Fourier transformation (STFT) operations, and wherein switching to the lower-latency configuration comprises using a first STFT frame size and switching to the higher-latency configuration comprises using a second STFT frame size longer than the first STFT frame size.

11. The ear-worn device of claim 9, wherein switching to the lower-latency configuration comprises the neural network circuitry implementing a first neural network and switching to the higher-latency configuration comprises the neural network circuitry implementing a second neural network more complex than the first neural network.

12. The ear-worn device of claim 9, wherein switching to the lower-latency configuration comprises the neural network circuitry implementing a specific head of a neural network with a first latency and switching to the higher-latency configuration comprises the neural network circuitry implementing a specific head of the neural network with a second latency longer than the first latency.

13. The ear-worn device of claim 9, wherein switching to the lower-latency configuration comprises using a first number of neural network-based results to generate each frame of output data and switching to the higher-latency configuration comprises using a second number of neural network-based results to generate each frame of output data, and the second number is larger than the first number.

14. The ear-worn device of claim 1, wherein the one or more post-neural network outputs comprise:
an enhanced audio signal generated using an output of the neural network;
a speech component separated from noise in an input audio signal; and/or
a mask configured to be applied to an input audio signal.

15. The ear-worn device of claim 1, wherein the own-voice detection circuitry is configured to perform correlation-based fusion of the one or more motion signals and the one or more post-neural network outputs.

16. The ear-worn device of claim 15, wherein the correlation-based fusion comprises one or more of cross-correlation analysis, coherence analysis in a frequency domain, mutual information techniques, dynamic time warping, canonical correlation analysis, phase-locked loop approaches, adaptive correlation filtering, wavelet coherence analysis, principal component analysis, Kalman filtering, particle filtering approaches, neural network-based fusion, statistical correlation tracking, or spectral correlation analysis.

17. The ear-worn device of claim 1, wherein the own-voice detection circuitry comprises second neural network circuitry configured to implement a fusion neural network trained to identify correlation patterns between the one or more motion signals and the one or more post-neural network outputs.

18. The ear-worn device of claim 17, wherein the fusion neural network is trained using paired audio and motion sensor data as input training data and labels indicating whether own-voice is present or absent as output training data.

19. The ear-worn device of claim 1, wherein the one or more post-neural network outputs comprise a neural network-generated prediction of own-voice.

20. The ear-worn device of claim 19, wherein the own-voice detection circuitry is configured to combine a first prediction based on the one or more motion signals and a second prediction based on the neural network-generated prediction to generate a composite own-voice detection prediction.
